(19) United States
(12) Patent Application Publication
(10) Pub. No.: US 2011/0123264 A1
(43) Pub. Date: May 26, 2011

(54) Conical Face Spline for Half-Shafts, Hub Bearings and the Like

(75) Inventor: Wenshui Wang, Shanghai (CN)

(73) Assignee: GM GLOBAL TECHNOLOGY OPERATIONS, INC., Detroit, MI (US)

(21) Appl. No.: 12/625,857

(22) Filed: Nov. 25, 2009

(51) Int. Cl. F16D 1/04

(52) U.S. Cl. 403/359.6

(57) ABSTRACT

A face spline having a conical, preferably frutoconical, configuration, referred to hereinbelow as a “conespline”, wherein the splines have increasing height with decreasing distance to the center of rotation. The conespline provides splines with greatest height and strength adjacent the center of rotation. An inverse conespline, geometrically reciprocal to a conespline, may be gearingly meshed with the conespline.

### TECHNICAL FIELD

The present invention relates to splines used to gearingly interconnect drive components with driven components of half-shafts, hub bearings, and the like, and more particularly to a conical face spline, or “conespline”.

### BACKGROUND OF THE INVENTION

Motor vehicles with driven axle independent suspensions include a pair of half-shafts (also referred to as split axles or axle shafts), one for each wheel, as for example described U.S. Pat. No. 4,699,235 issued on Oct. 13, 1987 to Anderson. By way of example, in rear wheel drive vehicles, a main output shaft is drivingly connected to a rear propeller shaft which in turn is drivingly connected to a rear differential in a manner well known in the art. Further by way of example, in front wheel drive vehicles, half-shafts connect a split axle drive mechanism to independently suspended and steerable front wheels, also in a manner well known in the art. Suitable half-shaft parts for connecting a drive mechanism to the driven wheels may include a plunging universal joint at the inboard end of the half-shafts and an Rzeppa-type universal joint or constant velocity (CV) joint at the outboard end of the half-shafts, adapted to be connected to the driven wheel.

Motor vehicles typically utilize wheel bearings to transfer powertrain torque to the driven wheels. An example of a wheel bearing featuring a face spline is described in U.S. Patent Application Publication 2008/0175526A1 to Langer et al (corresponding to WIPO patent application publication WO2006/092119A1), which describes a face spline of a toothed rim running in the circumferential direction around a rotation axis on a wheel-bearing arrangement for a driven wheel hub, wherein the face spline is provided for play-free engagement with a counter-spline, facing the face spline and the teeth of the face spline have a wedge-like embodiment such that the geometrical lines of the face spline meet centrally at a common point on the rotation axis and the teeth thus run in the radial direction on the rotation axis.

A face spline, as for example disclosed by Langer et al, has issues regarding mass, adequate support for the inner ring, as well as adequate support for the hub unit with respect to a CV or universal joint.

Accordingly, what is needed in the art is a face spline configuration which minimizes mass while maximizing strength for supporting of the inner ring the hub unit with respect to a CV or universal joint.

### SUMMARY OF THE INVENTION

The present invention is a face spline having a conical, preferably frustoconical, configuration, referred to herein as a “conespline”, having the splines thereof increasing in height with decreasing distance to the center of rotation. In another aspect of the present invention, an inverse conical geometry to the conespline, an “inverse conespline” has the splines thereof decreasing height with decreasing distance to the center of rotation, wherein a conespline and inverse conespline are mutually reciprocal for the purpose of being gearingly meshed to each other; however, it is possible to gearingly mesh a conespline with a conventional planar face spline. The conespline (and inverse conespline) according to the present invention may be integrated with any mechanical drive system, including by way of example half-shafts and hub bearings.

Accordingly, a number of advantages of the conespline according to the present invention include: ability to tighten the spline interface with higher torque than a conventional planar face spline, ability to reduce mass due to the three dimensional space provided by the conical shape in which to configure the inner ring and the conespline (a conventional planar face spline is essentially a two dimensional space); and ability to provide increased strength at the elevated central portion of the conespline, which inherently provides better strength and inner ring support than a conventional planar face spline. In particular, the ascendant conespline provides splines with greatest height and strength adjacent the center of rotation and adjoining the inner ring. As such, the inner ring is supported by the splines at the strongest, most robust, portion thereof.

Accordingly, it is an object of the present invention to provide a a conically configured face spline, or “conespline”.

This and additional objects, features and advantages of the present invention will become clearer from the following specification of a preferred embodiment.

### BRIEF DESCRIPTION OF THE DRAWINGS

FIG. 1A is a partly sectional side view of a half-shaft having a CV joint equipped with a conespline according to the present invention.

FIG. 1B is a perspective end view, seen along line 1B-1B of FIG. 1A.

FIG. 1C is a partly sectional side view of a half-shaft having a CV joint equipped with an inverse conespline according to the present invention.

FIG. 1D is a perspective end view, seen along line 1D-1D of FIG. 1C.

FIG. 2A is a hub bearing equipped with a conespline according to the present invention.

FIG. 2B is an end view, seen along line 2B-2B of FIG. 2A.

FIG. 2C is a partly sectional side view of a hub bearing equipped with an inverse conespline according to the present invention.

FIG. 2D is an end view, seen along line 2D-2D of FIG. 2C.

FIG. 3A is a perspective view of a conespline according to the present invention having a full conic shape.

FIG. 3B is a perspective view of a conespline according to the present invention having a frustoconic shape.

FIG. 4A is a sectional side view of a conespline according to the present invention, wherein the entire lower extent of the splines is integrated with the base portion.

FIG. 4B is a sectional side view of a conespline according to the present invention, wherein the periphery of the lower extent of the splines is integrated with the base portion.

FIG. 5 is a perspective view of a conespline spline (or tooth) having a trapezoidal shape.

FIG. 6A is a partly sectional, perspective view of an inverse conespline according to the present invention, having a frustoconic shape.

FIG. 6B is a sectional view taken along line 6B-6B of FIG. 6A.

FIG. 7A is a perspective view of a conespline of a hub bearing about to be gearingly meshed with an inverse conespline of a CV joint of a half-shaft.

FIG. 7B is a perspective view of a conespline of a CV joint of a half-shaft about to be gearingly meshed with an inverse conespline of a hub bearing.

FIG. 8 is a partly sectional side view of a conventional planar face spline interfaced with a conespline according to the present invention.

FIG. 8A is an end view of the conventional planar face spline which has been adapted for interfacing with the conespline according to the present invention, seen along line 8A-8A of FIG. 8.

FIG. 8B is a sectional side view, seen along line 8B-8B of FIG. 8A.

### DESCRIPTION OF THE PREFERRED EMBODIMENT

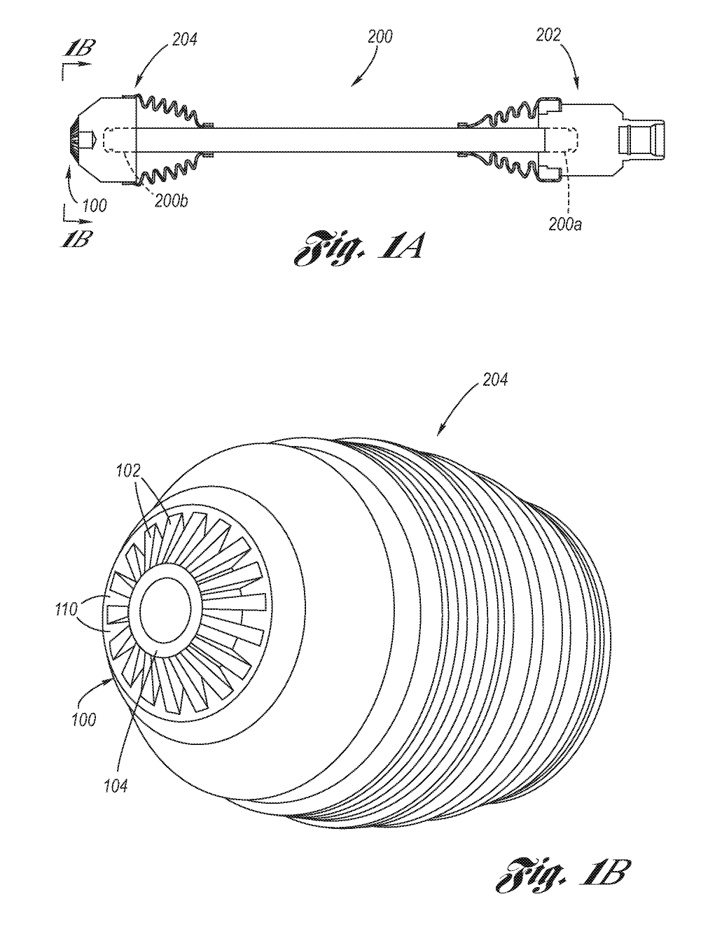

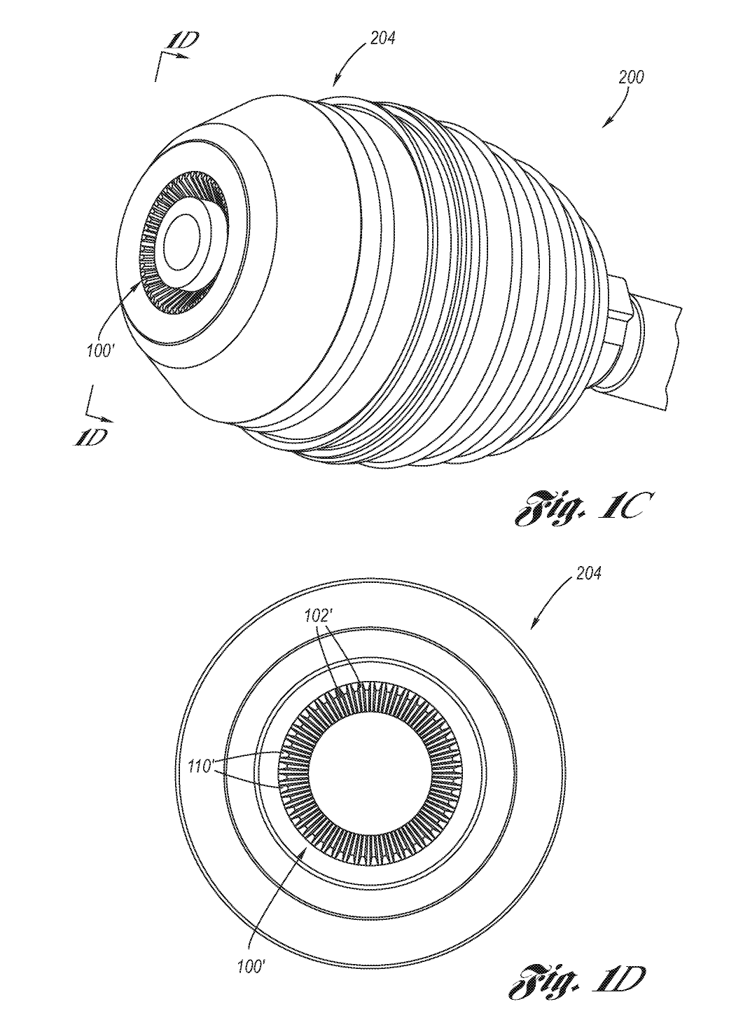

Referring now to the Drawing, FIGS. 1 through 8B depict various examples of a conic shaped face spline, referred to herein as a “conespline” 100, wherein the splines have increasing height with decreasing distance to the center of rotation. In a second aspect of the present invention, an inverse conically shaped face spline, referred to herein as an “inverse conespline 100′, is geometrically inverse or reciprocal to a conespline 100 (that is, the conespline and inverse conespline are mutually reciprocal), wherein the splines have decreasing height with decreasing distance to the center of rotation.

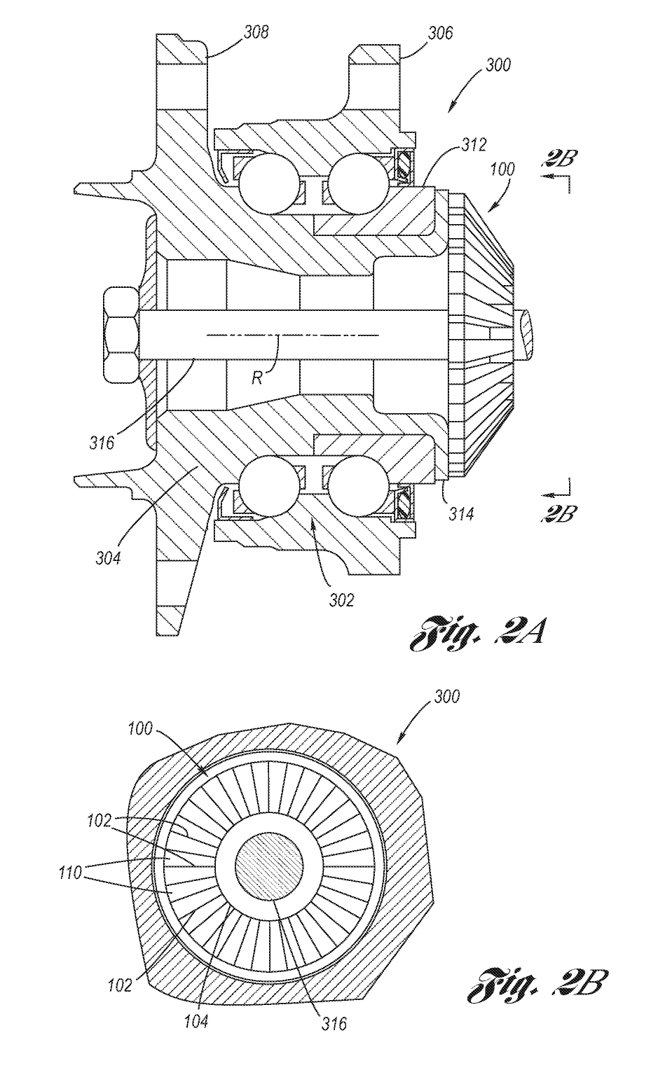

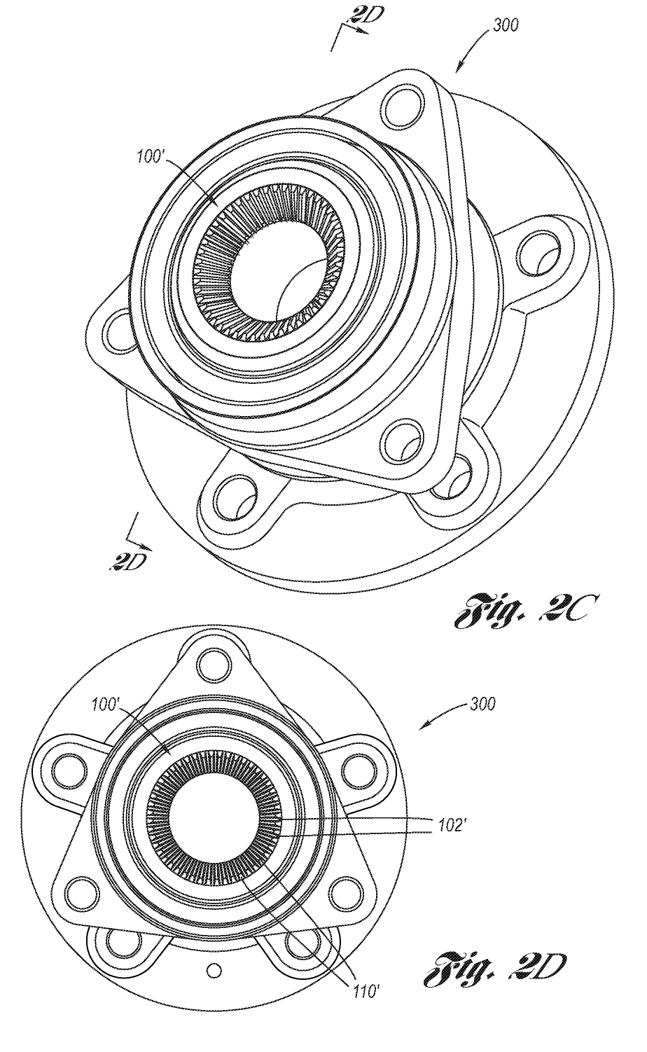

The conespline 100 (and the inverse conespline 100′) may be fitted, for non-limiting example, to: a half shaft 200, for example shown at FIGS. 1 and 1A with respect to a conespline 100, and for example shown at FIGS. 1C and 1D with respect to an inverse conespline 100′; or a hub bearing 300, for example shown at FIGS. 2A and 2B with respect to a conespline 100, and for example shown at FIGS. 2C and 2D with respect to an inverse conespline 100′. However, it is to be understood that the conespline 100 (and inverse conespline 100′) of the present invention may be utilized in other mechanical drive devices.

Referring to FIGS. 1A through 1D, the half-shaft 200, except for the conespline 100 and inverse conespline 100′, is otherwise conventional. As mentioned above, in front wheel drive vehicles, half-shafts 200 connect a split axle drive mechanism to independently suspended and steerable front wheels, also in a manner well known in the art. A suitable end part for a half-shaft 200 for connecting a drive mechanism to the driven wheels may include a plunging universal joint 202 at the inboard end 200a of the half-shafts and an Rzeppa-type universal joint or constant velocity (CV) joint 204 at the outboard end 200b of the half-shafts, adapted to be connected to the driven wheel (not shown). In this regard, the conespline 100 and the inverse conespline 100′ are respectively connected with the Rzeppa-type universal joint or constant velocity (CV) joint 204, by way of example.

Referring to FIGS. 2A through 2D, the hub bearing 300, except for the conespline 100 and inverse conespline 100′, is otherwise conventional. The hub bearing 300 includes bearings 302, a hub body 304 and a vehicle flange 306. A wheel flange 308 is connected to the hub body 304 for fastening of a driven wheel (not shown) and is mounted via the bearing 302 such that it can rotate about a center of rotation R with respect to the vehicle flange 304 which is fixed to the vehicle. An inner ring 312 of the hub bearing is configured into a hollow of the hub body 304, and a collar 314 is connected with the hub body 304 and is folded over radially to the outside thereof. A threaded bolt 316 passes through along the rotational axis. The conespline 100 and the inverse conespline 100′ are respectively connected, for example, by welding or integration, with the collar 314.

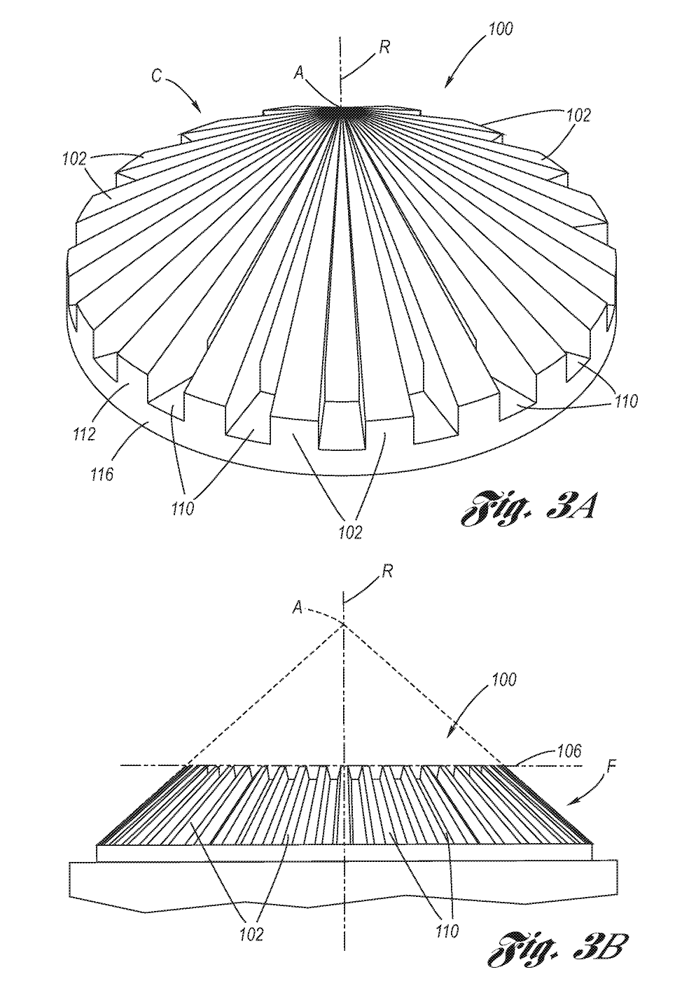

Turning attention next to FIGS. 3A through 6B, geometric aspects of the conespline 100 and the inverse conespline 100′ according to the present invention will be detailed.

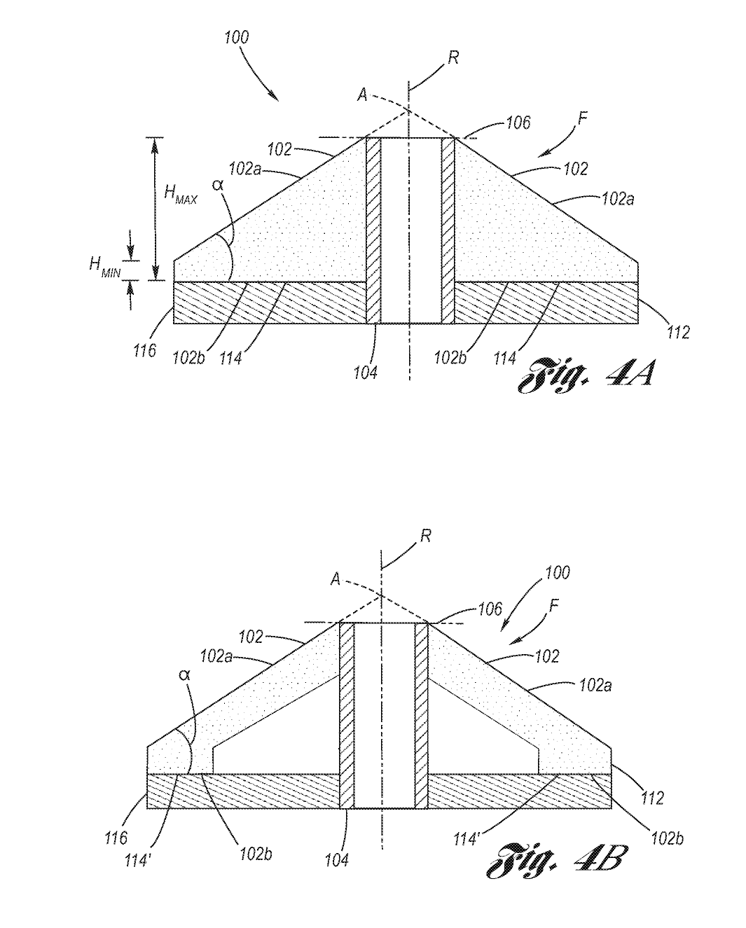

As shown at FIGS. 3A and 3B, the conespline 100 features splines (or teeth) 102 which have increasing height with decreasing distance to the center of rotation R. While the conic shape collectively provided by the splines 102 may include an apex A of a full cone shape C, as shown at FIG. 3A, preferably, as shown at FIG. 3B, the full cone is truncated by a plane 106 so as to provide the frustoconical shape F. In this regard, the frustoconical shape F of the conespline 100 shown at FIGS. 4A and 4B includes an inner ring 104 (of a hub bearing) which is disposed at the common annular center 108 of the splines 102.

As shown at FIGS. 4A and 4B, the splines 102 have an upper surface 102a which inclines upwardly from the periphery 112, away from the spline base 116 and toward an imaginary (or real) apex A, defined by a spline incline angle, α, which is an acute angle, and which by way of nonlimiting example, may be between about 3 degrees and about 77 degrees, preferably about 25 to about 45 degrees, and more preferably about 35 degrees, wherein the spline incline angle is positive, in the sense that the resulting configuration is conic.

As shown at FIG. 4A, the splines 102 of the conespline 100 may have a generally planar integration 114 with the spline base 116 of the conespline 100 extending across the entire lower extent 102b of the splines. Alternatively, as shown at FIG. 4B, the splines 102 at the periphery 112 of the conespline 100 may have a peripheral integration 114′ with the spline base 116 of the conespline, wherein from there the lower extent 102b of the splines is inclined generally parallel to the upper surface 102a thereof, that is preferably, but not necessarily, also at the spline incline angle, α.

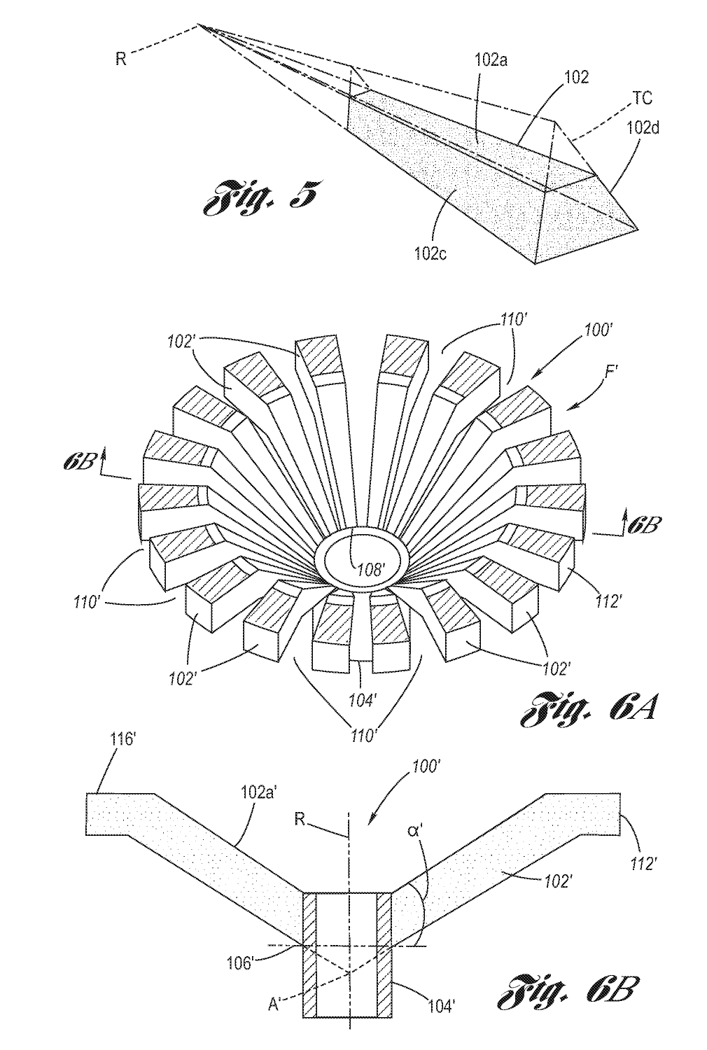

The splines 102 are separated from one another by respective slots 110, have a maximum height H_{MAX} at the common annular center 108 (closest to the center of rotation R), and a minimum height H_{MIN} at the periphery 112 of the conespline (farthest from the center of rotation). The shape of the splines is preferably trapezoidal, as discussed hereinbelow with respect to FIG. 5.

The number of splines is selected responsive to a particular application. Merely by way of non-limiting example, FIGS. 1A, 1B, 2A, 2B, 3A, 5A and 8 show 18 splines and 18 slots, and FIGS. 1C, 1D, 2C, 2D, 3B, 7A and 7B show 48 splines and 48 teeth; however, the number of splines (and teeth) may be between about 10 and 144, more preferably between about 18 and 72.

As can be best understood from FIG. 5, the splines 102 are preferably trapezoidal in shape, wherein the upper surface 102a is flat, being a planar truncation of an imaginary triangular cross-section TC, wherein the upper surface, as discussed hereinabove, is at an acute spline incline angle, α. Leading and trailing spline edges 102c, 102d are obtusely angled with respect to the upper surface 102a, and are further acutely converging from the periphery toward the center of rotation R such that the splines (and the slots) have radially decreasing width with decreasing distance to the center of rotation, consonant with the progressive reduction of the local circumference.

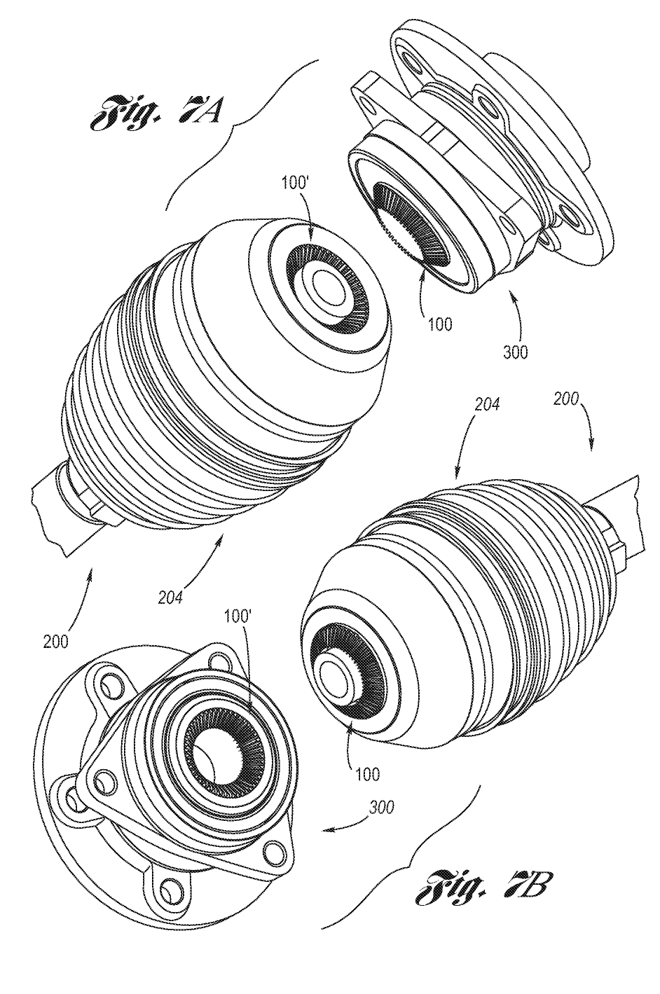

Turning attention now to FIGS. 6A and 6B, an inverse conespline 100′ is depicted. In that the inverse conespline 100′ is geometrically reciprocal or inverse to the conespline 100 for purposes of being gearingly meshed therewith, the splines (or teeth) 102′ thereof have decreasing height with decreasing distance to the center of rotation R′. While the conic shape collectively provided by the splines 102′ may include an apex A′ of a full cone shape (see FIG. 6B), preferably, the full cone is truncated by a plane 106′ so as to provide the frustoconical shape F′ of FIG. 6A. The inverse conespline 100′ may connect with an inner ring 104′ of a hub bearing, the inner ring being disposed at the common annular center 108′ of the splines 102′.

As shown at FIG. 6B, the splines 102′ have an upper surface 102a′ which inclines downwardly from the periphery 112′, away from the spline base 116′ (sectioned at FIG. 6A), and toward an imaginary (or real) apex A′, defined by a spline incline angle, α′, which is an acute angle, and which by way of nonlimiting example, may be between about 3 degrees and about 77 degrees, preferably about 25 to about 45 degrees, and more preferably about 35 degrees, wherein the spline incline angle is negative in the sense that the resulting configuration is inversely conic.

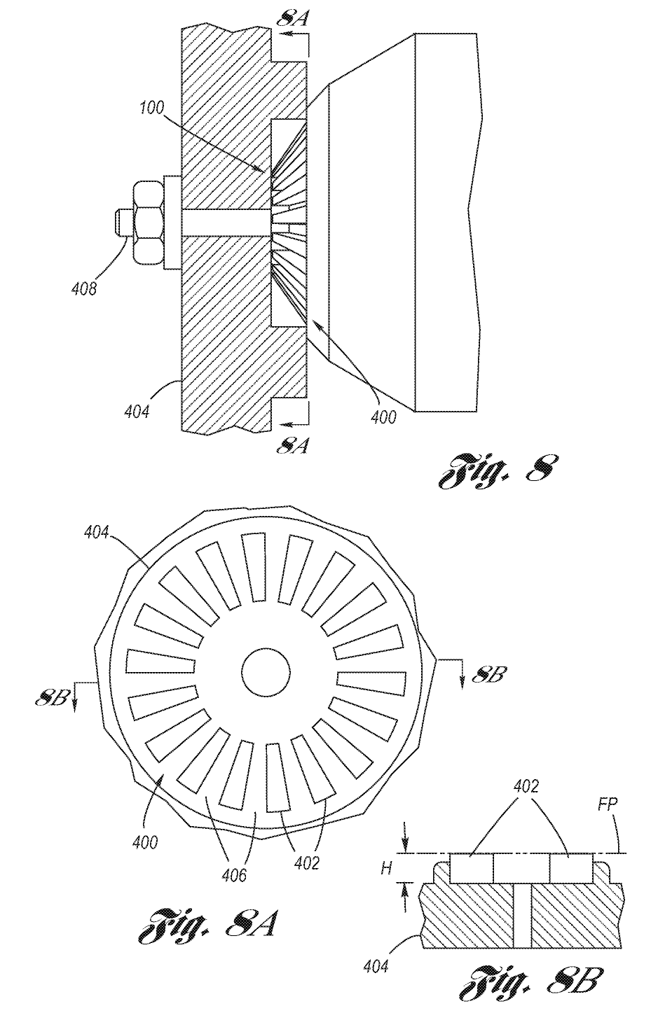

Turning attention now to FIGS. 7A through 8B, examples of operation of the conespline 100 according to the present invention will be detailed.

As shown at FIG. 7A, a half shaft 200 having a CV or universal joint 204 provided with an inverse conespline 100′ which is gearingly meshed with a hub bearing 300 provided with a conespline 100, wherein each of the conespline and the inverse conespline has 48 teeth and 48 slots, and wherein the spline incline angle and trapezoidal shape of the splines is selected to provide self-centering as between the mutually reciprocally shaped conespline and inverse conespline.

As shown at FIG. 7B, a half shaft 200 having a CV or universal joint 204 provided with a conespline 100 which is gearingly meshed with a hub bearing 300 provided with an inverse conespline 100′, wherein each of the conespline and the inverse conespline has 48 teeth and 48 slots, and wherein the spline incline angle α and trapezoidal shape of the splines is selected to provide self-centering as between the mutually reciprocally shaped conespline and inverse conespline.

FIGS. 8 through 8B show an example of a conespline 100 in operation with respect to a conventional planar face spline.

The conespline 100 is located, for example, on either of a half-shaft universal or CV joint (i.e., as shown at FIGS. 1A and 1B) or a hub bearing (i.e., as shown at FIGS. 2A and 2B). The conespline 100 is gearingly meshed (interfaced) with a conventional planar face spline 400. The planar face spline 400 has a plurality of planar splines 402 which are generally conventional, being connected to a base 404 and presenting a flat face plane FP to the conic shape of the conespline 100. The number of planar splines 402 of the planar face spline 400 matches the number of slots 108 of the conespline 100, and the number of slots 406 of the planar face spline matches the number of splines 102 of the conespline, so that they are gearingly meshed with one another. The height H of the planar splines 402 is uniform and about equal to the maximum height H_{MAX} of the splines 102 of the conespline 100. A tightening bolt 408 may or may not be present depending on the application (wherein, by example, the tightening bolt would be present for the hub bearing application of FIGS. 2 and 2A).

It will be seen from the foregoing description that the conespline 100 provides tightening of the spline interface with higher torque than that possible with a pair of conventional face splines, reduction in mass in that there is a three dimensional space in which to configure the inner ring of the hub bearing and the conespline, and higher strength at the elevated central portion, which inherently provides better inner ring support than a conventional face spline.

To those skilled in the art to which this invention appertains, the above described preferred embodiment may be subject to change or modification. Such change or modification can be carried out without departing from the scope of the invention, which is intended to be limited only by the scope of the appended claims.

1. A conically shaped face spline, comprising:
a conespline comprising:
a spline base; and
a plurality of splines connected to said spline base, each spline being mutually separated from each other spline by a respective slot, said plurality of splines collectively having a periphery;
wherein each spline of said plurality of splines has an upper surface upwardly inclined from said periphery in a direction away from said spline base toward an apex at a predetermined positive acute spline incline angle.

2. The conically shaped face spline of claim 1, wherein the conical shape is a frustoconical shape, and said apex is an imaginary apex.

3. The conically shaped face spline of claim 1, wherein each said spline has a trapezoidal shape.

4. The conically shaped face spline of claim 1, wherein said acute angle is substantially between about 3 degrees and about 77 degrees.

5. The conically shaped face spline of claim 4, wherein said acute angle is substantially between about 25 degrees and about 45 degrees.

6. The conically shaped face spline of claim 5, wherein said acute angle is substantially about 35 degrees.

7. The conically shaped face spline of claim 3, wherein the conical shape is a frustoconical shape, and said apex is an imaginary apex.

8. The conically shaped face spline of claim 7, wherein said acute angle is substantially between about 3 degrees and about 77 degrees.

9. An inverse conically shaped face spline, comprising:
an inverse conespline comprising:
a spline base; and
a plurality of splines connected to said spline base, each spline being mutually separated from each other spline by a respective slot, said plurality of splines collectively having a periphery;
wherein each spline of said plurality of splines has an upper surface downwardly inclined from said periphery toward an apex at a predetermined negative acute spline incline angle.

10. The inverse conically shaped face spline of claim 9, wherein the conical shape is a frustoconical shape, and said apex is an imaginary apex.

11. The inverse conically shaped face spline of claim 9, wherein each said spline has a trapezoidal shape.

12. The inverse conically shaped face spline of claim 9, wherein said acute angle is substantially between about 3 degrees and about 77 degrees.

13. The inverse conically shaped face spline of claim 12, wherein said acute angle is substantially between about 25 degrees and about 45 degrees.

14. The inverse conically shaped face spline of claim 13, wherein said acute angle is substantially about 35 degrees.

15. The inverse conically shaped face spline of claim 11, wherein the conical shape is a frustoconical shape, and said apex is an imaginary apex.

16. The inverse conically shaped face spline of claim 15, wherein said acute angle is substantially between about 3 degrees and about 77 degrees.

17. A conically shaped face spline for being gearingly meshed with an inverse conically shaped face spline, comprising:
a conespline comprising:
a first spline base; and
a plurality of first splines connected to said spline base, each first spline being mutually separated from each other first spline by a respective first slot, said plurality of first splines collectively having a first periphery;
wherein each first spline of said plurality of first splines has a first upper surface upwardly inclined from said first periphery in a direction away from said first spline base toward a first apex at a predetermined positive acute spline incline angle; and
an inverse conespline comprising:
a second spline base; and
a plurality of second splines connected to said second spline base, each second spline being mutually separated from each other second spline by a respective second slot, said plurality of second splines collectively having a second periphery;
wherein each second spline of said plurality of second splines has a second upper surface downwardly inclined from said second periphery toward a second apex at a predetermined negative acute spline incline angle;
wherein said plurality of first splines are gearingly meshable with respect to said plurality of second splines.

18. The conically shaped face spline for being gearingly meshed with an inverse conically shaped face spline of claim 17, wherein the conical shape is a frustoconical shape, and said apex is an imaginary apex.

19. The conically shaped face spline for being gearingly meshed with an inverse conically shaped face spline of claim 17, wherein each said spline has a trapezoidal shape.

20. The conically shaped face spline for being gearingly meshed with an inverse conically shaped face spline of claim 17, wherein said acute angle is substantially between about 3 degrees and about 77 degrees.
